(19) United States
(12) Patent Application Publication
(10) Pub. No.: US 2007/0057587 A1
(43) Pub. Date: Mar. 15, 2007

(54) Environmental protection start system free of energy source

(76) Inventor: Jue-Fu Lin, Banchiau City (TW)

Correspondence Address: Jue-Fu Lin, P.O. Box No. 6-57, Taipei, 235, TW

(21) Appl. No.: 11/223,107

(22) Filed: Sep. 12, 2005

(51) Int. Cl. H02K 49/00; H02P 15/00

(52) U.S. Cl. 310/103; 74/DIG. 4

(57) ABSTRACT

The present invention provides an environmental protection start system free of energy source, including at least a magnetic movable set, a magnetic cathode transmission gear set and a small amplification transmission gear set. A negative pole of the magnetic movable set is moved towards the magnetic cathode transmission gear set, thereby producing a strong repelling force between negative polarities, which then causes a transmission gear set to rotate. A small amplification transmission gear set is then used to drive a large amplification transmission gear set, thereby achieving a start system that functions to produce an amplified force and speed.

### BACKGROUND OF THE INVENTION

(a) Field of the Invention

The present invention relates to an environmental protection start system free of an energy source, and more particularly to a start system that uses the principle of mutual repelling between negative poles of magnets to produce a resilience force. In addition, the start system utilizes transmission gear sets to produce an amplified speed and force by means of size amplification, thereby providing the start system with functionality for uninterrupted rotation, which serves as a replacement for a traditional start system that requires the employment of various forms of energy sources.

(b) Description of the Prior Art

Nuclear fission, nuclear fusion and solar energy forms of energy sources have been booming in recent years. However, fossil fuels, such as coal, oil, natural gas, and so on, are still the energy source people depend on and use the most, with oil being the most important and most strategic energy source and fundamental raw material of modern industrial society.

However, untapped quantities of fossil fuels are limited, and are being increasingly depleted day by day. Moreover, fossil fuels are nonuniformly distributed and cause severe pollution when burnt. Furthermore, a global oil crisis occurred twice during the 1970s, which caused a sharp rise in oil prices and an economic decline, and prompted countries worldwide to actively engage in research to reduce reliance on oil in order to prevent an oil problem from further impacting on the economy.

However, oil still accounts for forty percent of total consumption of existing energy sources around the world. Based on current investment in production equipment and applied technology, it is estimated that fossil fuels can only maintain their standing as the mainstream energy source up to the end of the century. Hence, there is an urgent priority for people to search for easier to use fuels and to intensify improving technological use of existing energy sources.

Furthermore, untapped quantities of natural energy sources remain finite while being gradually depleted because of an increasing population and uninterrupted growth in amount of energy expended by each person. Current estimates state that remaining coal, oil and natural gas reserves will be exhausted in a few decades. In other words, the human race will be facing a significant energy crisis in approximately fifty years.

In order to contend with this energy crisis, realistically addressing the “demand aspect” to increase efficiency and economical use of energy is more important than the “supply aspect” to develop new energy sources. Hence, countries worldwide are emphasizing the importance of all forms of research and development in regenerating energy sources, and people in modern societies are finally realizing that energy sources cannot be wantonly wasted. Hence, new energy sources and improvement in efficient use of existing energy sources are actively being developed, while ensuring that existing living standards are maintained and that industrial progress and economic growth are not retarded in attempting to economize on use of energy sources.

However, the genuine meaning of saving on energy sources does not entail not using energy sources, which would reduce living standards, but instead to paying more attention to increasing efficiency in the use of energy sources and decreasing unnecessary waste. Nevertheless, apart from relying on the government to promote measures to encourage saving energy, moreover, a nationwide concerted effort is required in order to achieve genuine energy savings.

In light of the aforementioned, the inventor of the present invention, having decades of experience in energy source research and development, ultimately designed the present invention.

### SUMMARY OF THE INVENTION

Accordingly, a primary objective of the present invention is to provide an environmental protection start system free of an energy source that eliminates the need for fuel or an energy source when a system is being driven and achieves auto-start functionality.

In order to achieve the aforementioned objectives, the present invention transmits a resilience force produced from mutual repellence of identical magnet poles through a set of large and small transmission gears, thereby producing an amplified energy, and further achieving the postulated objectives of a start function and saving on all energy sources.

To enable a further understanding of said objectives and the technological methods of the invention herein, brief description of the drawings is provided below followed by detailed description of the preferred embodiments.

### BRIEF DESCRIPTION OF THE DRAWINGS

FIG. 1 shows a set-up schematic view of a first preferred embodiment according to the present invention.

FIG. 2 shows a set-up schematic view of a second preferred embodiment according to the present invention.

### DETAILED DESCRIPTION OF THE PREFERRED EMBODIMENTS

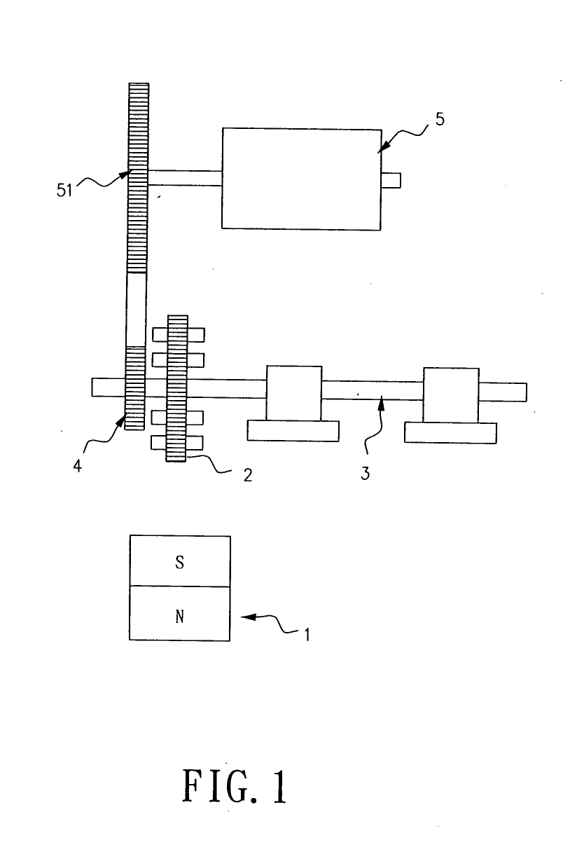

Referring to FIG. 1, which shows a set-up schematic view of a first preferred embodiment of the present invention, wherein is depicted an environmental protection start system free of energy source of the present invention, which is structured to comprise at least a magnetic movable set 1, a magnetic cathode transmission gear set 2, a transmission gear set support 3, a small amplification transmission gear set 4 and a start system 5. An external force is applied to the magnetic movable set 1 having a positive and a negative pole to cause a default orbital displacement. The magnetic cathode transmission gear set 2 having a negative and a positive pole is pivot disposed on the transmission gear set support 3 to correspond to the aforementioned magnetic movable set 1. The small amplification transmission gear set 4 is further pivot disposed on the transmission gear set support 3, thereby enabling a transmission gear set so formed to positionally pivot rotate. The small amplification transmission gear set 4 disposed on the transmission gear set support 3 together with the magnetic cathode transmission gear set 2 disposed adjacent thereof on the transmission gear set support 3 collectively pivotal rotate when the magnetic cathode transmission gear set 2 rotates. A large amplification transmission gear set 51 connects to and drives the start system 5 when rotating. Rotating of the transmission gear set 51 is realized through pivot rotation of the small amplification transmission gear set 4, and the rotating transmission gear set 51 drives a leather belt, a chain, a gear wheel, and so on.

When using the present invention, the magnetic movable set 1 is moved towards the magnetic cathode transmission gear set 2, thereby producing a strong repelling force between the two corresponding identical magnetic poles (cathodes are used as an exemplary example in the embodiment of the present invention), which drives and rotates the magnetic cathode transmission gear set 2 that further rotates the small amplification transmission gear set 4 coaxially disposed on the same transmission gear set support 3. At this time, a different rotating speed gear ratio is produced at the start system 5 because of rotation of the small amplification transmission gear set 4 driving the large amplification transmission gear set 51 connected to the start system 5, thereby providing a torque and rotating speed that drives the start system 5. Hence, the start system 5 is provided with rotating functionality.

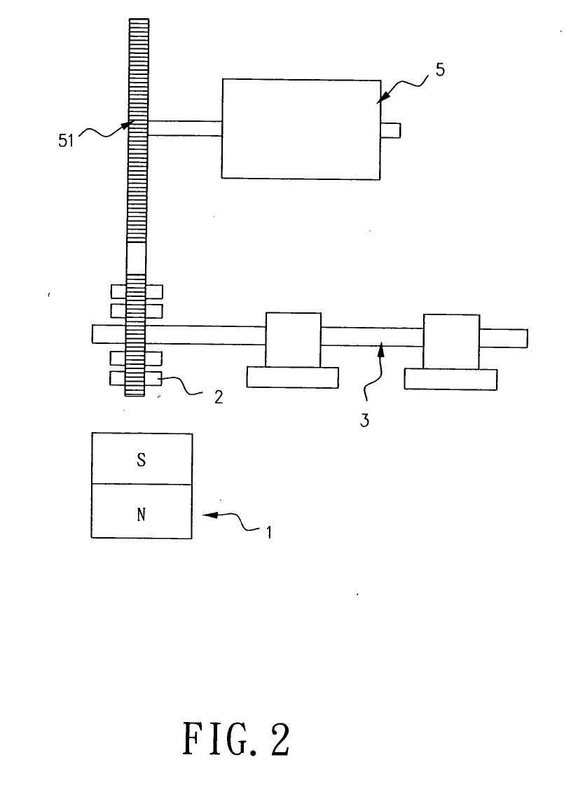

Referring to FIG. 2, which shows a set-up schematic view of a second preferred embodiment, which differs with the aforementioned first embodiment in that the small amplification transmission gear set 4 originally pivotal disposed on the transmission gear set support 3 has been removed, and direct use is made of the magnetic cathode transmission gear set 2 as a replacement, which drives the start system 5 through the large amplification transmission gear set 51. Remaining structure and driving method of the second embodiment is identical to those of the first embodiment, and thus not further detailed hereinafter.

From the aforementioned it can be known that the environmental protection start system free of energy source of the present invention achieves the anticipated objective of a drive function that eliminates the need for fuel or an energy source when driving a start system, and is of commercial use. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An environmental protection start system free of energy source, comprising:
a magnetic movable set structured to have a positive and a negative pole;
a transmission gear set support, on which is pivot disposed a small amplification transmission gear set and a magnetic cathode transmission gear set; the magnetic cathode transmission gear set is disposed so as to correspond to the magnetic movable set; and
a start system connected to a large amplification transmission gear set, wherein the small amplification transmission gear set drives the large amplification transmission gear set.

2. The environmental protection start system free of energy source according to claim 1, wherein the magnetic movable set and the magnetic cathode transmission gear set are correspondingly disposed so that like magnetic poles are facing each other.

3. An environmental protection start system free of energy source, comprising:
a magnetic movable set structured to have a positive and a negative pole;
a transmission gear set support, on which is pivot disposed a magnetic cathode transmission gear set; the magnetic cathode transmission gear set is disposed so as to correspond to the magnetic movable set; and
a start system connected to a large amplification transmission gear set, wherein the magnetic cathode transmission gear set drives the large amplification transmission gear set.

4. The environmental protection start system free of energy source according to claim 3, wherein the magnetic movable set and the magnetic cathode transmission gear set are correspondingly disposed so that like magnetic poles are facing each other.
